(19) United States
(12) Patent Application Publication
(10) Pub. No.: US 2003/0068419 A1
(43) Pub. Date: Apr. 10, 2003

(54) Food bar compositions

(75) Inventors: Cindy D. Pollard, New South Wales (AU); Bernadette A. Mitchell, New South Wales (AU)

Correspondence Address: OSTROLENK FABER GERB & SOFFEN, 1180 AVENUE OF THE AMERICAS, NEW YORK, NY, 100368403

(73) Assignee: Vital Woman Pty Limited

(21) Appl. No.: 09/729,059

(22) Filed: Dec. 4, 2000

(51) Int. Cl. A21D 6/00

(52) U.S. Cl. 426/549; 426/496

(57) ABSTRACT

A food composition is provided having about 1 mg/g to 2 mg/g of isoflavones and about 30 to about 60% by weight of an edible component containing at least one ingredient selected from the group consisting of fruit, fruit derivatives and mixed spices. The edible component masks or substantially reduces the bitter taste of the isoflavones without the need to add large amounts of refined sugars or fats.

### TECHNICAL FIELD

This invention relates to food compositions and more particularly to compositions containing soy isoflavones and/or soy protein. The compositions are useful for food bars.

### BACKGROUND ART

Phytoestrogens are naturally occurring plant compounds that share a similar biological structure to human oestrogen. One particular class of phytoestrogens are isoflavones and research studies suggest that a regular dietary intake of isoflavones is associated with many health benefits, including a reduction in the incidence of menopause symptoms, osteoporosis, heart disease, and certain cancers (breast, prostate). Soybeans are the most significant dietary sources of isoflavones.

The isoflavone contents in commercial soy raw ingredients vary depending on the levels of isoflavones in the plant variety and processing procedures.

Isoflavones has been found to have beneficial effects on human health in doses of approximately 60 mg per day. However, the taste of isoflavones in foods in quantities necessary to provide this dosage is found to be unpleasant to many people. Masking of the taste has typically been achieved by using large amounts of refined sugars or fats. However, use of large amounts of refined sugars or fats is generally considered to be unhealthy.

Research by the National Heart Foundation in Australia has shown that one in two men are at risk of developing heart disease from the age of forty. High blood cholesterol and lack of exercise are major risk factors for heart disease and stroke. There is now substantial evidence to show that diets rich in soy foods can significantly reduce blood cholesterol levels. The USA Food and Drug Administration (FDA) has recently announced that diets low in saturated fat and cholesterol, which contain twenty five grams of soy protein per day as four servings of 6.25 grams, may reduce the risk of heart disease. In addition, soy protein is an excellent source of protein in that 100% of essential amino acids can be digested from this protein source. This is particularly important for growing bodies (children and teenagers) as well as people aged over forty when a breakdown in protein occurs resulting in muscle deterioration and a decline in fitness levels. The taste of soy protein in foods in quantities necessary to provide this dosage is found to be unpleasant to many people. Masking of the taste has typically been achieved by using large amounts of refined sugars or fats. However, use of large amounts of refined sugars or fats is generally considered to be unhealthy.

Reference is made to the following:

1. Albertazzi, P. et al. (1998). “The effect of dietary soy supplementation on hot flashes”. Obstetrics and Gynaecology 91: o-11.

2. Bakhit, R. M. et al. (1994) “Intake of 25 g of soybean protein with or without soybean fiber alters plasma lipids in men with elevated cholesterol concentrations ” Journal of Nutrition 124: 213-222.

3. Barnes, S et al. 1995 “Rationale for the use of genistem-containing soy matrices in chemoprevention trials for breast and prostate cancer”. Journal of Cellular Biochemistry 255: 181-187.

4. Erdman, J. W. et al. 1996) “Short-term effects of soy isoflavones on bone in postmenopausal women.” Second international Symposium on the role of soy in preventing and treating chronic disease. Brussels, Belgium

5. Henley, E. C. and Kuster, J. M. (1994). “Protein quality evaluation by protein digestibility-corrected amino acid scoring. Food Technology 48: 74-77.

6. National Heart Foundation (1999). “Heart, Stroke and Vascular Diseases Australian Facts 1999 Highlights”. www.heartfoundation.au

7. Negata. C. et al. (1998), “Decreased serum total cholesterol concentration is associated with high intake of soy products in Japanese men and women.” Journal of Nutrition 128: 209-213.

8. Potter, S. M. et al. (1998). “Soy protein and isoflavones: Their effects on blood lipids and bone density in postmenopausal women”. American Journal of Clinical Nutrition.

### SUMMARY OF THE INVENTION

The present invention relates to food compositions which inventively include soy isoflavones and or soy protein and other compounds which, unexpectedly, provide in combination with the soy isoflavones and or soy protein a pleasant tasting food bar without the need for large amounts of added refined sugars or fats. The taste of the soy isoflavones and or soy protein is masked or substantially reduced in preferred embodiments of the invention. One of the aims of preferred embodiments of one form of the invention is to produce a bar containing about 45 to 90 mg and preferably at least about 60 mg soy isoflavones per serving. Aims of preferred embodiments of a second form of the invention are a bar containing about 6.25 grams or more of soy protein per serving.

In one broad form, the invention provides a food composition for making a baked food bar, the composition comprising:

a about 1 mg g to 2 mg/g of isoflavones, and

b about 30 to 60% weight of an edible component containing at least one ingredient selected from the group consisting of fruit, fruit derivatives and mixed spices.

The food composition is preferable for making a food bar and more preferable a baked food bar. Evidence suggests that soy isoflavones are heat stable and so it is believed that a baked food bar weighing about 45 g will provide between about 45 and about 90 mg and preferably at least 60 mg of isoflavone compounds per serving.

The invention in a second broad form, also provides a baked food bar, the baked food bar comprising:

a. about 1 mg g to about 2 mg/g in baked product of isoflavones, and

b. about 30 to about 60by weight of one or more ingredients selected from the group consisting of fruit, fruit derivatives and mixed spices.

The isoflavones may be provided in pure or substantially pure form but are preferably provided in the form of a natural soybean concentrate, herein called isoflavone concentrate. Preferably the isoflavone concentrate also contains between about 10% and about 50% by weight of soy proteins. The isoflavones are normally provided in an isoflavone concentrate and the weight percent of isoflavones within the isoflavone concentrate is highly variable between batches.

The fruit and fruit derivatives may be provided by undiluted fruit juice, fruit juice concentrates, dried fruit, mixed peel or citrus oil.

The food composition and the bar may include fruit or fruit pulp. The fruit may be one or more selected from dried apricots, sultanas, dates (diced or past), figs, mixed peel. Other fruits may be used. When fruit is included, the percentage by weight of the total fruits may be between about 20% and about 40% and more preferably between about 25% and about 35%.

The food composition and the bar may include one or more fruit juices or fruit juice concentrates. The fruit juices or fruit juice concentrate may be selected from one or more of orange, mandarin, raspberry, grape, lime, lemon. Other fruit juices or fruit juice concentrates may be used. Preferably there is between about 5% and about 3% and more preferably between about 7% and about 30% by weight of fruit juice and fruit juice concentrates.

When orange juice concentrate is used the concentration of the orange fruit juice concentrate is preferably between about 50 brix and about 65 brix.

When mandarin fruit juice concentrate is used the concentration of the mandarin fruit juice concentrate is preferably between about 50 brix and about 70 brix and more preferably between about 55 brix and about 65 brix.

When grape fruit juice concentrate is used the concentration of the grape fruit juice concentrate is preferably between about 55 brix and about 75 brix and more preferably between about 60 brix and about 70 brix.

When raspberry fruit juice concentrate is used the concentration of the raspberry fruit juice concentrate is preferably between about 55 brix and about 75 brix and more preferably between about 60 brix and about 70 brix.

When lime fruit juice concentrate is used the concentration of the lime fruit juice concentrate is preferably between about 40 brix and about 75 brix and more preferably between about 45 brix and about 70 brix. When lime juice concentrate is used water is added to a ratio of preferably between about 1.5 parts water to 1 part lime concentrate and about 4 parts water to 1 part lime concentrate and more preferably between about 2 parts water to 1 part lime concentrate and about 3 parts water to 1 part lime concentrate.

When lemon fruit concentrate is used the concentration of the lemon fruit juice concentrate is preferably between about 40 brix and about 75 brix and more preferably; between about 45 brix and about 70 brix. When lemon fruit juice concentrate is used water is added to a ratio of preferably between about 1.5 parts water to 1 part lemon concentrate and about 4 parts water to 1 part lemon concentrate and more preferably between about 2 parts water to 1 lemon concentrate and about 3 parts water to 1 part lemon concentrate.

The food composition and the bar may include flour and more preferably wholemeal flour. When flour in included, the percentage by weight of the flour in the dough is preferably between about 12.5% and about 17.5% and more preferably between about 14% and about 16%.

White flour may be used but wholemeal flour is preferred so as to provide dietary fiber.

The food composition and the bar may include semolina. When semolina is included, the percentage by weight of the semolina is preferably between about 12.5% and about 17.5% and more preferably between about 14% and about 16%.

The food composition and the bar may include baking powder. Other leavening agents such as sodium bicarbonate, sodium acid pyrophosate, calcium carbonate, ammonium bicarbonate and tartaric acid may be used. When baking powder is included, the percentage by weight of the baking powder is preferably between about 1.4% and about 2.2% and more preferably between about 1.0% and about 2.0%. If one or more other leavening agents are used they are included in an effective amount.

The food composition and the bar may include honey. When honey is included, the percentage by weight of the honey is preferably between about 8% and about 18% and more preferably between about 10% and about 16%.

The food composition and the bar may include water. When added water is included, the percentage by weight of the added water is preferably between about 0% and about 10% and more preferably between about 0% and about 8%.

The food composition and the bar may include mixed spices. When mixed spices are included, the percentage by weight of the mixed spices is preferably between about 0.5% and about 2.0% and more preferably between about 0.7and about 1.5%.

The food composition and the bar may include glycerine. When glycerine is included, the percentage by weight of the glycerine is preferably between about 1% and about 6% and more preferably between about 2% and about 4%.

The food composition and the bar may include added refined sugar. When added refined sugar is included in the composition, the percentage by weight of added refined sugar is preferably between about 1% and about 5% and more preferably, between about 1.5% and about 2.5%.

Preferably the total fat content of the composition and the bar is less than about 5% and more preferably less than about 3%.

The food composition and the bar may include added oils and fats, preferably a vegetable oil.

The food composition and the bar may include canola oil. When canola is included, the percentage by weight of the canola oil is preferably between about 0% and about 5% and more preferably between about 0% and about 2%.

The food composition and the bar may include olive oil. When olive oil is included, the percentage by weight of the olive oil is preferably between about 0% and about 5% and more preferably between about 0% and about 3%.

The food composition and the bar may include soy chocolate. When soy chocolate is included, the percentage by weight of the soy chocolate is preferably between about 5% and about 20% and more preferably between about 0% and about 15%.

The food composition and the bar may include poppy seeds. When poppy seeds are included, the percentage by weight of the poppy seeds is preferably between about 0% and about 10% and more preferably between about 0% and about 5%.

The food composition and the bar may include desiccated coconut. When desiccated coconut is included, the percentage by weight of the desiccated coconut is preferably between about 0% and about 10% and more preferably between about 0% and about 5%.

The food composition may contain citrus oil and the citrus oil may be selected from one or more of orange, mandarin, lime, lemon. Other citrus oils may be used. When citrus oil is included, the percentage by weight of citrus oil may be between about 0.1% and about 0.7%. More preferably it is between about 0.2% and about 0.6%. Citrus fruit juice concentrates have their citrus oil removed prior to the extraction of the fruit juice concentrate and so if fresh fruit juice, as opposed to concentrated fruit juice, is used the amount of citrus oil added may be reduced or eliminated, if desired.

The total added sugar content of the food composition is preferably less than about 15%. More preferably less than about 2% by weight of the composition is added refined sucrose Preferably the major portion of sugars in the composition is provided by fruit or fruit juice (concentrated and un-concentrated) or by honey (about 83% sugars). In preferred forms of the invention more than 50% of the sugar component of the product is fructose (fruit sugar).

The food composition and the bar preferably contains vitamins and minerals. The vitamins preferably include A, B1, B2, B3, B6, Folate & E and the minerals include Calcium, Iron & Zinc. The following table 1 shows the amount of each vitamin mineral added per finished product (45 gram cooked bar). Substrate carrier for vitamins/minerals may be included such as maltodextrin at a rate of 0% to 20% In the following need to keep the source flexible, e.g., calcium may be provided by calcium carbonate or triphosphate.

TABLE 1

| Vitamin/Mineral | Amount | | % RDI | Source |
|---|---|---|---|---|
| Vitamin A | 0.19 | mg | 25% | Beta-Carotene as Beta- |
| | | | | Carotene 10% CWS |
| Vitamin B1 (thiamine) | 0.55 | mg | 50% | Thiamine hydrochloride |
| Vitamin B2 (riboflavin) | 0.43 | mg | 25% | Riboflavin |
| Vitamin B3 (niacin) | 2.5 | mg | 25% | Nicotinamide |
| Vitamin B6 (pyridoxine) | 0.4 | mg | 25% | Pyridoxine hydrochloride |
| Vitamin B9 (folate) | 0.1 | mg | 50% | Folic acid |
| Vitamin E | 2.5 | mg | 25% | di-alpha-Tocophenyl |
| | | | | acetate |
| Calcium | 200 | mg | 25% | Calcium carbonate |
| Iron | 3 | mg | 25% | Ferric pyrophosphate |
| Zinc | 1.8 | mg | 15% | Zinc sulphate |
| | | | | monohydrate |

In a third broad form the invention provides a composition for making a baked food bar, the composition comprising:

a. about 5 to about 15% by weight of soy protein, and

b. about 40 to about 55% by weight of one or more ingredients selected from the group consisting of fruit, fruit derivatives and mixed spices.

The invention, in a fourth broad form, also provides a baked food bar, the baked food bar comprising:

a. about 5 to about 15% by weight of soy protein, and

b. about 40 to about 55% by weight of one or more ingredients selected from the group consisting of fruit, fruit derivatives and mixed spices.

The fruit and fruit derivatives may be provided by undiluted fruit juice, fruit juice concentrates, dried fruit, mixed peel or citrus oil.

The food composition is preferably for making a food bar and more preferably a baked food bar. Evidence suggests that soy protein is heat stable and so it is believed that in one embodiment of the invention a baked food bar weighing about 75 g will provide approximately 6.25 grams of soy protein.

The soy protein may be provided in pure or substantially pure form but is preferably provided in the form of a dry powdered soy protein isolate. Preferably the isolate also contains between about 0% and about 3% by weight of soy isoflavones.

The food composition and the bar may include fruit and fruit derivatives including dried fruit, fruit juice, fruit juice concentrates, mixed peel, citrus oil or fruit pulp. The fruit may be one or more selected from dried apricots, sultanas, dates, figs, mixed peel. Other fruits may be used. When fruit is included in the composition, the percentage by weight of the total fruits may be between about 10% and about 35% and more preferably between about 15% and about 30%.

The food composition and the bar may include one or more fruit juices or fruit juice concentrate. The fruit juice may be selected from one or more of orange, mandarin, raspberry, grape, lime, and lemon. Other fruit juices may be used. Preferably there is between about 10% and about 35% and more preferably between about 15% and about 30% by weight of fruit juice and fruit juice concentrate.

The food composition and the bar may include citrus oil. When is included, the percentage by weight of citrus oil may be between about 0.1% and about 0.7%. More preferably it is between about 0.1% and about 0.6%.

The food composition and the bar may include flour and more preferably wholemeal flour. When flour is included, the percentage by weight of the flour is preferably between about 7% and about 13% and more preferably between about 8% and about 12%.

White flour may be used but wholemeal flour is preferred so as to provide dietary fiber.

The food composition and the bar may include semolina. When semolina is included, the percentage by weight of the semolina is preferably between about 7% and about 13% and more preferably between about 8% and about 12%.

The food composition and the bar may include baking powder. Other leavening agents such as sodium bicarbonate, sodium acid pyrophosate, calcium carbonate, ammonium bicarbonate, and tartaric acid may be used. When baking powder is included, the percentage by weight of the baking powder is preferably between about 0.5% and about 3.0% and more preferably between about 0.1% and about 2.0%. If one or more other leavening agents are used, they are included in an effective amount.

The food composition and the bar may include honey. When honey is included, the percentage by weight of the honey in the dough is preferably between about 5% and about 15% and more preferably between about 7% and about 12%.

The food composition and the bar may include added sugar. When added sugar is included, the percentage by weight of the added sugar in the dough is preferably between about 0% and about 5% and more preferably between about 0% and about 2%.

The food composition and the bar may include glycerine. When glycerine is included, the percentage by weight of the glycerine in the dough is preferably between about 1% and about 6% and more preferably about 2% and about 4%.

The food composition and the bar may include roasted soybeans. When roasted soybeans are included, the percentage by weight of the roasted soybeans in the dough is preferably between about 5% and about 20% and more preferably between about 7% and about 12%.

The food composition and the bar may include added water. When added water is included, the percentage by weight of the added water in the dough is preferably between about 0% and about 10% and more preferably between about 0% and about 5%.

The food composition and the bar may include soy chocolate. When soy chocolate is included, the percentage by weight of the soy chocolate in the dough is preferably between about 0% and about 20% and more preferably between about 0% and about 15%.

The total added sugar content of the food composition is preferably less than about 15%. Preferably less than 2% by weight is added as refined sugar. Preferably the sugars are provided by fruit or fruit juice (concentrated and un-concentrated) or by honey (about 83% sugar).

Preferably the total fat of the composition is less than about 5% and more preferably less than 5%.

The food composition preferably contains vitamins and minerals. The vitamins preferably include A, B1, B2, B3, B6, Folate & E and the minerals include Calcium, Iron & Zinc. The amount of each vitamin mineral added per finished 75 gram bar is as per table 1

### DESCRIPTION OF PREFERRED EMBODIMENTS OF THE INVENTION

A first food bar composition to a first form of the invention was prepared utilizing the ingredients of table 2 and cooked to form a number of food bars

TABLE 2

| | Weight (grams) | Weight % |
|---|---|---|
| Wholemeal Flour | 752 | 15.6994% |
| Semolina | 752 | 15.6994% |
| Baking Powder | 94 | 1.9624% |
| Honey | 658 | 13.7370% |
| Sultanas | 752 | 15.6994% |
| Figs | 612 | 12.7766% |
| Isoflavone concentrate | 250 | 5.2192% |
| Vitamins/Minerals | 59 | 1.2317% |
| Raspberry Fruit Juice | 294 | 6.1378% |
| Conc. Brix about 65-66 | | |
| Grape Fruit Juice | 294 | 6.1378% |
| Conc. Brix about 68 | | |
| Glycerine | 118 | 2.4635% |
| White Sugar | 94 | 1.9624% |
| Canola Oil | 14 | 0.2923% |
| Lemon Juice | 47 | 0.9812% |
| Total Weight | 4790 | |

The Vitamins include A, B1, B2, B3, B6, Folate & E and the minerals include Calcium, Iron & Zinc as per table 1 and are diluted with a suitable carrier or diluent to provide 15%-50% of the RDI of the specified vitamins/minerals in a baked 45 gram bar made according to composition.

The ingredients are divided into three main fractions—dry, fruit and wet. The dry ingredients including wholemeal flour, semolina, baking powder, soy protein extract isoflavone concentrates, vitamins/mineral premix, sugar, etc., were mixed together.

The sultanas and figs were diced where necessary and added to the dry ingredients.

The wet ingredients, including the fruit juices, fruit juice concentrates, fruit pulp pastes, honey, water, glycerine, citrus oils, etc., were mixed together and heated to about 90 degrees Celsius with occasional stirring to make the liquid less viscous to facilitate working into and mixing with the dry and fruit ingredient mix.

The heated wet ingredients were added to the mixture of dry and fruit ingredients and mixed until all ingredients were combined (for about 5 minutes) using a dough mixer.

The dough was placed into a tray lined with greaseproof paper to a thickness of about 1.5 cm.

A separate sheet of greaseproof paper was placed on top of the dough and then rolled with a rolling pin over the greaseproof paper to smooth the surface. The top layer of greaseproof paper was removed and the tray placed in a preheated oven at about 160 degrees Celsius for about 28 minutes.

The tray was removed from the oven and allowed to cool at room temperature for about 2 hours before slicing into individual bars approximately ×5 cm×3.5 cm surface area and depth of 2 cm (after cooking) with a minimum weight of about +5 grams and packaged.

In practice the weight of bars range from +5 to 65 grams.

The bars were found to have a pleasant taste without a noticeable bitterness associated with the isoflavone.

A second food composition according to a first form of the invention was prepared utilizing the ingredients of table 3.

TABLE 3

| | Weight (grams) | Weight % |
|---|---|---|
| Wholemeal Flour | 752 | 14.4755% |
| Semolina | 752 | 14.4775% |
| Baking Powder | 94 | 1.8094% |
| Honey | 658 | 12.6660% |
| Sultanas | 470 | 9.0472% |
| Dates | 752 | 14.4755% |
| Mixed Peel | 235 | 4.5236% |
| Isoflavone concentrate | 250 | 4.5236% |
| Vitamins Minerals | 59 | 1.1357% |
| Lime Juice Conc. | 75 | 1.4437% |
| No 1 Brix about 51.6 | | |
| Grape Fruit Juice Conc. Brix about 68 | 376 | 7.2377% |
| Lime Juice Conc. No 2 Brix about 65 | 47 | 0.9047% |
| Glycerine | 188 | 3.6189% |
| White Sugar | 94 | 1.8094% |
| Desiccated Coconut | 108 | 2.0789% |
| Water | 320 | 5.7748% |
| Total Weight | 5230 | |

The vitamins include A, B1, B2, B3, B6, Folate & E and the minerals include Calcium, Iron & Zinc as per table 1 and are diluted with a suitable carrier or diluent to provide 15% to 50% of the RDI of specified vitamins minerals in a baked 45 gram bar made according to the composition.

The ingredients were prepared in a similar manner to the first composition and cooked for about 25 minutes at about 190 degrees Celsius at which time the surface was golden brown.

The tray was removed from the oven and allowed to cool at room temperature for about 2 hours before slicing into individual bars approximately ×5 cm×3.5 cm surface area and depth of 2 cm (after cooking) with a weight of about 45 grams and packaged.

The bars were found to have a pleasant taste without a noticeable bitterness associated with the isoflavones.

A third food composition according to a first form of the invention was prepared utilizing the ingredients of table 4.

TABLE 4

| | Weight (grams) | Weight % |
|---|---|---|
| Wholemeal Flour | 752 | 14.4978% |
| Semolina | 752 | 14.4978% |
| Baking Powder | 94 | 1.8122% |
| Honey | 658 | 12.6856% |
| Dried Apricots | 470 | 9.0611% |
| Sultanas | 823 | 15.8666% |
| Date Paste | 353 | 6.8055% |
| Isoflavone concentrate | 250 | 4.8197% |
| Vitamins/Minerals | 59 | 1.1375% |
| Water | 59 | 1.1375% |
| Mixed Spice | 47 | 0.9061% |
| Orange Fruit Juice Conc. Brix about 63.5 | 470 | 9.0611% |
| Grape Fruit Juice Conc. Brix about 68 | 118 | 2.2749% |
| Glycerine | 118 | 2.2749% |
| White Sugar | 94 | 1.8122% |
| Canola Oil | 70 | 1.3495% |
| Total Weight | 5187 | |

The vitamins include A, B1, B2, B3, B6, Folate & E and the minerals include Calcium, Iron & Zinc as per table 1 and are diluted with a suitable carrier or diluent to provide 15% to 50% of the RDI of specified vitamins/minerals in a baked 45 gram bar made according to the composition.

The ingredients were prepared and cooked and packaged as per the second composition, except for cooking at about 170 degrees Celsius for about 28 minutes.

The bars were found to have a pleasant taste without a noticeable bitterness associated with the isoflavones.

A fourth food composition was prepared utilizing the ingredients of table 5

TABLE 5

| | Weight (grams) | Weight % |
|---|---|---|
| Wholemeal Flour | 752 | 15.1613% |
| Semolina | 752 | 15.1613% |
| Baking Powder | 94 | 1.8952% |
| Dried Apricots | 950 | 19.1532% |
| Isoflavone concentrate | 250 | 5.0403% |
| Vitamins/Minerals | 59 | 1.1895% |
| Mandarin Fruit Juice Conc. Brix about 63.5 | 350 | 7.0565% |
| Orange Fruit Juice Conc. Brix about 63.5 | 300 | 6.0484% |
| Grape Fruit Juice Conc. Brix about 68 | 650 | 13.1048% |
| Glycerine | 120 | 2.4194% |
| Olive Oil | 23 | 0.4637% |
| Mixed Peel | 500 | 10.0806% |
| Poppy seeds | 140 | 2.8226% |
| Mandarin Citrus Oil | 20 | 0.4032% |
| Total Weight | 4960 | |

The vitamins include A, B1, B2, B3. B6. Folate & E and the minerals include Calcium, Iron & Zinc as per table 1 and are diluted with a suitable carrier of diluent to provide 15 to 50% of the RDI of specified vitamins minerals in a baked 45 gram bar made according to the composition.

The ingredients were prepared and cooked and packaged as per the third composition, in particular at about 170 degrees Celsius for about 28 minutes. The bars were found to have a pleasant taste without a noticeable bitterness associated with the isoflavones.

A fifth food composition according to the third form of the invention was prepared utilizing the ingredients of table 6.

TABLE 6

| | Weight (grams) | Weight % |
|---|---|---|
| Wholemeal Flour | 612 | 10.4802% |
| Semolina | 612 | 10.4802% |
| Baking Powder | 68 | 1.1645% |
| Soy Protein Isolate | 238 | 4.0756% |
| Honey | 544 | 9.3157% |
| Dried Apricots | 510 | 8.7335% |
| Sultanas | 612 | 10.4802% |
| Mandarin Fruit Juice Conc. Brix about 63.5 | 408 | 6.9868% |
| Orange Fruit Juice Conc. Brix about 63.5 | 408 | 6.9868% |
| Grape Fruit Juice Conc. Brix about 68 | 540 | 5.8223% |
| Sugar | 102 | 1.7467% |
| Glycerine | 153 | 2.6200% |
| Vitamins Minerals | 46 | 0.7877% |
| Roasted soybeans | 644 | 0.3157% |
| Mandarin Citrus Oil | 13.6 | 0.2329% |
| Water | 85 | 1.4556% |
| Soy Chocolate | 544 | 9.3157% |
| Total Weight | 5839.6 | |

The Vitamins include A, B1, B2, B3, B6, Folate & E and the minerals include Calcium, Iron & Zinc as per table 1 and are diluted with a suitable carrier or diluent to provide 15 to 50% of the RDI of specified vitamins minerals in a baked 75 gram bar made according to the composition.

The ingredients were prepared and cooked and packaged similarly to the other compositions but cooked at about 170 degrees Celsius for about 30 minutes. The bars were found to have a pleasant taste without a noticeable bitterness.

It will be appreciated by a person skilled in the art that numerous variations and or modifications may be made to the present invention as shown in the specific embodiment without departing from the spirit or scope of the invention as broadly described. The present embodiment is, therefore, to be considered in all respects to be illustrative and not restrictive.

1. A food composition for making a baked food bar, the composition comprising:
about 1 mg/g to 2 mg/g of isoflavones, and
about 30 to about 60% by weight of an edible component containing at least one ingredient selected from the group consisting of fruit, fruit derivatives and mixed spices.

2. The food composition of claim 1 wherein the fruit and fruit derivatives include undiluted fruit juice, fruit juice concentrates, dried fruit, mixed peel, citrus oil or dried fruit pulp.

3. The food composition of claim 1 wherein the percentage by weight of the total fruits is between about 20% and about 40%.

4. The food composition of claim 1 wherein said edible component includes one or more fruit juices or fruit juice concentrate.

5. The food composition of claim 1 wherein there is between about 5% and about 35% by weight of fruit juice and fruit juice concentrate.

6. The food composition of claim 1 including between about 12.5% and about 17.5% by weight of flour.

7. The food composition of claim 1 including between about 12.5% and about 17.5% by weight of the semolina.

8. The food composition of claim 1 comprising:
about 20% to about 30% by weight of fruit;
about 9% to about 30% by weight of fruit juice or fruit juice concentrate or both;
about 14% to about 16% by weight of flour;
about 14% to about 16% by weight of semolina;
about 0% to about 14% by weight of honey; and
about 0% to about 10% by weight of mixed peel.

9. A baked food bar made using a food composition according to claim 1.

10. A composition for making a baked food bar, the composition comprising:
about 5 to about 15% by weight of soy protein; and
about 40 to about 55% by weight of an edible component containing at least one ingredient selected from the group consisting of fruit, fruit derivatives and mixed spices.

11. The food composition of claim 10 wherein the fruit and fruit derivatives include undiluted fruit juice, fruit juice concentrate, dried fruit, mixed peel, citrus oil or dried fruit pulp.

12. The food composition of claim 10 wherein the percentage by weight of the total fruit is between about 10% and about 35%.

13. The food composition of claim 10 wherein said edible component includes one or more fruit juices or fruit juice concentrates.

14. The food composition of calm 10 wherein there is between about 10% and about 35% by weight of fruit juice and fruit juice concentrates.

15. The food composition of 10 including between about 7% and about 13% by weight of flour.

16. The food composition of claim 10 including between about 7% and about 13% by weight of the semolina.

17. The food composition of claim 10 including between about 0% and about 20% by weight of soy chocolate.

18. The food composition of claim 10 including between about 0% and about 15% by weight of honey.

19. The food composition of claim 10 comprising:
about 15% to about 30% by weight of fruit;
about 15% to about 30% by weight of fruit juice or fruit juice concentrate or both;
about 8% to about 12% by weight of flour;
about 8% to about 12% by weight of semolina;
about 0% to about 15% by weight of honey; and
about 0% to about 20% by weight of chocolate.

20. A baked food bar made using a food composition according to claim 10.

21. A baked food bar comprising:
about 1 mg to 2 mg of isoflavones; and
about 30 to about 60% by weight of an edible component containing at least one ingredient selected from the group consisting of fruit, fruit derivatives and mixed spices.

22. The baked food bar of claim 21 wherein the fruit and fruit derivatives include undiluted fruit juice, fruit juice concentrates, dried fruit, mixed peel, citrus oil or dried fruit pulp.

23. The baked food bar of claim 21 wherein the percentage by weight of the total fruit is between about 20% and about 40%.

24. The baked food bar of claim 21 wherein said edible component includes one or more fruit juices or fruit juice concentrates.

25. The baked food bar of claim 21 wherein there is between about 5% and about 35% by weight of fruit juice and fruit juice concentrate.

26. The baked food bar of claim 21 including between about 12.5% and about 17.5% by weight of flour.

27. The baked food bar of claim 21 including between about 12.5% and about 17.5% by weight of the semolina.

28. The baked food bar of claim 21 comprising:
about 20% to about 30% by weight of fruit;
about 9% to about 30% by weight of fruit juice or fruit juice concentrate or both;
about 14% to about 16% by weight of flour;
about 14% to about 16% by weight of semolina;
about 0% to about 14% by weight of honey; and
about 0% to about 10% by weight of mixed peel.

29. A composition for making a baked food bar. The composition comprising:
5 to about 15% by weight of soy protein; and
about 40 to about 55% by weight of an edible component containing at least one ingredient selected from the group consisting of fruit, fruit derivatives and mixed spices.

30. The baked food bar of claim 29 wherein the fruit and fruit derivatives include undiluted fruit juice, fruit juice concentrate, dried fruit, mixed peel, citrus oil or dried fruit pulp.

31. The baked food bar of claim 29 wherein the percentage by weight of the total fruits is between about 10% and about 35%.

32. The baked food bar of claim 29 wherein said edible component includes one or more fruit juices or fruit juices concentrate.

33. The baked food bar of claim 29 wherein there is between about 10% and about 35% by weight of fruit juice and fruit juice concentrates.

34. The baked food bar of claim 29 including between about 7% and about 13% by weight of flour.

35. The baked food bar of claim 29 including between about 7% and about 13% by weight of the semolina.

36. The baked food bar of claim 29 including between about 0% and about 20% by weight of soy chocolate.

37. The baked food bar of claim 29 including between about 0% and about 15% by weight of honey.

38. The baked food bar of claim 29 comprising:
about 15% to about 30% by weight of fruit;
about 15% to about 30% by weight of fruit juice or fruit juice concentrate or both;
about 8% to about 12% by weight of flour;
about 8% to about 12% by weight of semolina;
about 0% to about 15% by weight of honey; and
about 0% to about 20% by weight of soy chocolate.
